(19) United States
(12) Patent Application Publication
(10) Pub. No.: US 2016/0019222 A1
(43) Pub. Date: Jan. 21, 2016

(54) Method of Displaying a Location Associated with a User

(71) Applicant: Farouk Al-Shorafa, Naples, FL (US)

(72) Inventor: Farouk Al-Shorafa, Naples, FL (US)

(21) Appl. No.: 13/846,770

(22) Filed: Mar. 18, 2013

(51) Int. Cl. G06F 17/30; H04L 29/06; H04L 29/12; H04L 29/08

(52) U.S. Cl. CPC G06F 17/30061; H04L 67/306; H04L 65/403; H04L 61/609; G06F 17/30867; G06F 17/30554

(57) ABSTRACT

A method having the steps of receiving a user name associated with a profile on a social networking service; receiving user information associated with a user name; receiving public information associated with a user name; determining, by one or more processors, a user match; identifying a location that matches the location associated with the user name; and providing the location associated with a user name for display.

### CROSS-REFERENCE TO RELATED APPLICATION

This application claims the benefit of priority to U.S. Provisional Application No. 61/612,243 filed on Mar. 16, 2012, which is incorporated herein by reference in its entirety.

### BACKGROUND

Online social media can provide valuable information on the Internet that may be harvested to generate information and other data about people, products or services, branding, competition, and industries. Social media is becoming a crucial and rapidly growing source of consumer opinion. This information may allow users to quantify opinion on social media sites to gain useful insights into current consumer sentiment and trends relating to people, products or services, brands, and/or technologies, and those of their competitors. Collecting and presenting this information can help users in a variety of ways such as, for example, target advertising revenues and expenditures, marketing, sales, customer service, brand management, product development, investor relations, and the like.

### SUMMARY OF THE INVENTION

The present disclosure pertains to a method having the steps of receiving, by one or more processors, a user name associated with a profile on a social networking service; receiving, by one or more processors, user information associated with a user name; receiving, by one or more processors, public information associated with a user name; determining, by one or more processors, a user match; identifying, by one or more processors, a location that matches the location associated with the user name; and providing, by the one or more processors, the location associated with a user name for display.

One aspect of the disclosure is a method having the step of comparing, by one or more processors, the public information to the user information. Another aspect of the disclosure is a method having the step of determining, by one or more processors, a user name for display. Another aspect of the disclosure is a method having the step of filtering, by one or more processors, a list of user names by the desired piece of characteristic information. Another aspect of the disclosure is a method having the step of verifying, by one or more processors, an identified location by comparing the identified location against a storage database of known locations. Another aspect of the disclosure is a method having the step of parsing, by one or more processors, user information and/or public information.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a block diagram of a network according to an exemplary embodiment.

FIG. 2 is a block diagram of an electronic device according to an exemplary embodiment.

FIG. 3 is a flow chart of a process according to an exemplary embodiment.

FIG. 4 is a web display according to an exemplary embodiment.

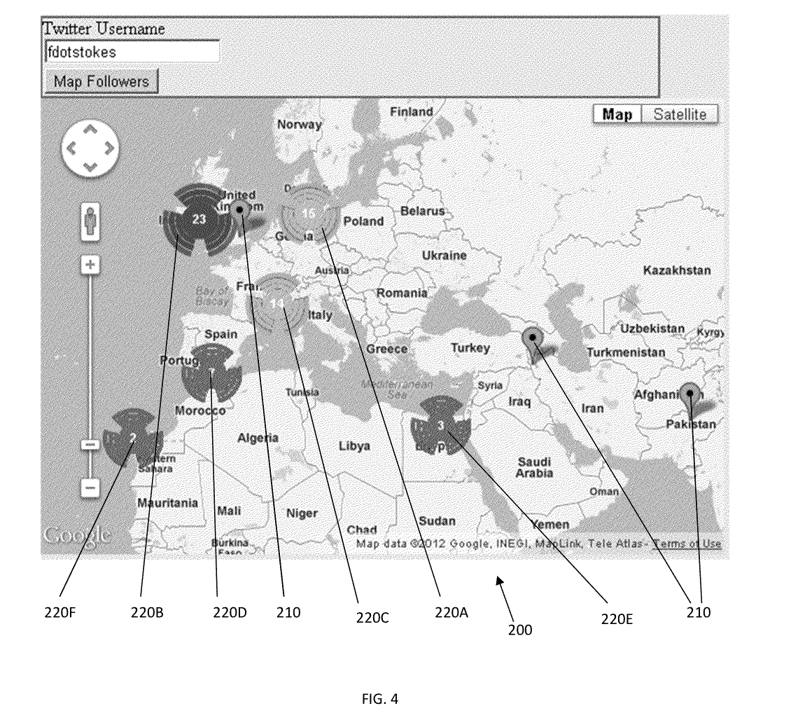

### DETAILED DESCRIPTION

To aid in understanding aspects of the invention described herein, some terms used in this description are defined below.

As used herein, the term “overlap” refers to the obscuring or hiding of a portion or all of a graphical marker by one or more other graphical markers rendered on the same display map.

As used herein, the term “zoom-in” refers to decreasing the field of size of a display map by changing the view from wide to a narrower. Zooming-in typically increases the amount of detail over a narrower or smaller area of a map or image, such as the effect of increasing a magnification level.

As used herein, the term “zoom-out” refers to increasing the field of vision by changing the view from narrow to a wider view. Zooming-out typically displays a larger or wider area of a map or image with a decreased amount of detail over that area, such as the effect of decreasing a magnification level.

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

The present disclosure pertains to a method for displaying a location of a user of a social networking service on a display map. Such graphical representations can be used by operators, such as a person associated with a business, restaurant, political candidate, entertainer, or the like, to determine where to focus marketing resources or business development efforts, such as advertisements, new locations, events, or the like.

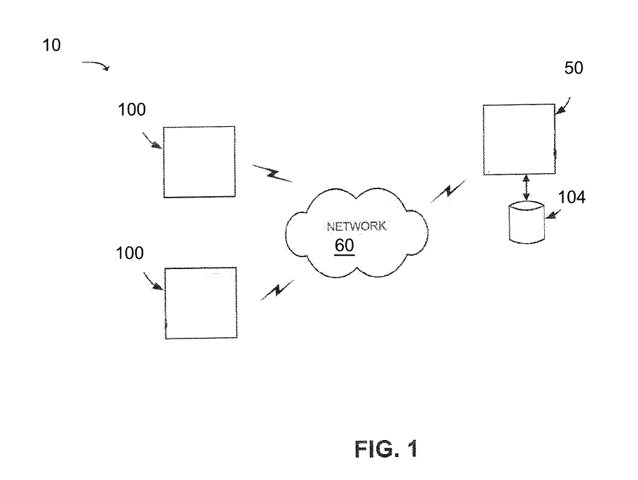

FIG. 1 shows an illustrative electronic device 100 for providing an application for interfacing with a host. Electronic device 100 can include control circuitry 102, storage 104, memory 106, input/output (“I/O”) circuitry 108, and communications circuitry 110. In some embodiments, one or more of the components of the electronic device 100 can be combined or omitted (e.g., storage 104 and memory 106 may be combined). In some embodiments, the electronic device 100 can include other components not combined or included in those shown in FIG. 1 (e.g., a display), or several instances of the components shown in FIG. 1. Only one of each of the components is shown in FIG. 1.

The electronic device 100 can include any suitable type of electronic device 100. For example, the electronic device 100 can include a substantially fixed electronic device 100, such as a desktop computer. As another example, electronic device 100 can include a larger portable electronic device 100, such as a laptop or tablet computer. As another example, the electronic device 100 can include a portable electronic device 100 that the respondent may hold in his or her hand, such as a digital media player, a personal e-mail device, a personal data assistant (“PDA”), a cellular telephone, a handheld gaming device, or a digital camera.

Control circuitry 102 can include any processing circuitry or unit including a microprocessor, or processor operative to control the operations and performance of the electronic device 100 and interpret and execute instructions. For example, control circuitry 102 can be used to run operating system applications, firmware applications, media playback applications, media editing applications, or any other application. In some embodiments, control circuitry 102 can drive a display and process inputs received from an interface.

Storage 104 can include, for example, one or more storage mediums including a hard-drive, solid state drive, flash memory, permanent memory such as ROM, any other suitable type of storage component, or any combination thereof. Storage 104 can store, for example, application data (e.g., for implementing functions on the electronic device 100), firmware, respondent preference information data (e.g., account information), authentication information (e.g. libraries of data associated with authorized respondents), and any other suitable data or any combination thereof.

Memory 106 can include cache memory 106, semi-permanent memory such as RAM, and/or one or more different types of memory 106 used for temporarily storing data. In some embodiments, memory 106 can also be used for storing data used to operate electronic device 100 applications, or any other type of data that can be stored in storage 104. In some embodiments, memory 106 and storage 104 can be combined as a single storage 104 medium. In some embodiments, memory 106 and storage 104 are coupled to the processing unit.

I/O circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of I/O circuitry 108 can be included in electronic device 100.

Electronic device 100 can include any suitable interface or component for allowing a respondent to provide inputs to I/O circuitry 108. For example, electronic device 100 can include any suitable input mechanism, for example, a button, keypad, mouse, dial, a click wheel, or a touch screen. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to communications device with a wire or wirelessly).

In some embodiments, I/O circuitry 108 can include display circuitry (e.g., a screen or projection system) for providing a display visible to the respondent. For example, the display circuitry can include a screen (e.g., an LCD screen) that is incorporated into electronic device 100. As another example, the display circuitry can include a movable display or a projecting system for providing a display of content on a surface remote from electronic device 100 (e.g., a video projector). In some embodiments, the display circuitry can include a coder/decoder (Codec) to convert digital media data into analog signals. For example, the display circuitry (or other appropriate circuitry within the electronic device 100) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the electronic device 100, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry 110 operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth®, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

Electronic device 100 can include one or more instances of communications circuitry 110 for simultaneously performing several communications operations using different communications networks, although only one is shown in FIG. 1. For example, electronic device 100 can include a first instance of communications circuitry 110 for communicating over a cellular network, and a second instance of communications circuitry 110 for communicating over Wi-Fi or using Bluetooth®. In some embodiments, the same instance of communications circuitry 110 can be operative to provide for communications over several communications networks.

In one embodiment, the electronic device 100 may include an application to interface with at least one server thereby providing the electronic device 100 with the ability to create and present transmissions to a server. For example, through the application of the electronic device 100, the user can connect to a host server, website server, or the like. The host server can be any server that receives and transmits communication between the electronic device 100 and the host. For example, the host server can receive communication from the host and transmit the communication to the electronic device 100. The website server can be any server associated with a website associated with a survey session 210. In one embodiment, the website server communicates directly with the electronic device 100. The software instructions defining the application may be read into memory 106 from another computer-readable medium, such as storage device 104, or from another device via I/O circuitry 108. The software instructions contained in memory 106 cause control circuitry 102 to perform processes. In one embodiment, hardwired circuitry may be used in place of or in combination with software instructions to implement processes consistent with the present disclosure.

In one embodiment, a network 10 in which systems and methods consistent with the principles of the disclosure may be implemented. Network 10 may include multiple electronic devices 100 connected to one or more servers 50 via a network 60. Communication between the electronic device 100 and the host server, the electronic device 100 and the website server, and the host server and the website server may be accomplished through any suitable network that may be provided by one or more communication interface, for example, WLAN, WAN, or LAN connection. Specifically, by way of example, the network may be a wireless internet connection established by way of the WLAN interface, a local area network connection established through the LAN interface, or a wide area network connection established by way of the WAN interface, which may include one of various WAN mobile communication protocols, such as a General Packet Radio Service (GPRS) connection, an EDGE connection (Enhanced Data rates for GSM Evolution connection), or a 3G connection, such as in accordance with the IMT-2000 standard. One or more of the data encryption techniques and security protocols (e.g., SSL or TSL protocols) may be further utilized in order to facilitate the secure transmission of the data (e.g. session information) from the electronic device 100 to the host server.

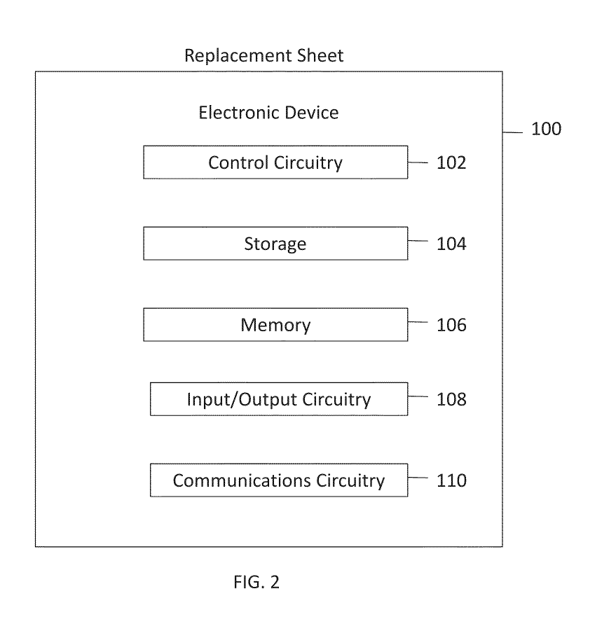

In one embodiment, as shown in FIG. 2, the method has the step of receiving a user name or a list of user names associated with a profile on a social networking service. A user name can represent an account associated with a user of a social networking service. A profile can refer to an account of an individual or business of interest to a user. Associations between a user name and a profile on a social networking service can be user names elected as a follow status of the profile on a social networking service, user names selected as friends of the profile on a social networking service, user names elected as a like status of the profile on a social networking service, or the like. In one embodiment, the software application receives a user name or a list of user names associated with a profile on a social networking service. A user name of the user can be obtained by performing a name query of a database provided by a social networking service that stores user names. For example, a name query can be performed by application program interface (API), web query, or standard query language (SQL) request.

In one embodiment, the method has the step of receiving user information associated with a user name. User information can have location information and characteristic information associated with a user name. Location information can be any information identifying a location associated with a user name, for example, address, city, street, zip code, coordinate data, email address, the like, or any combination thereof. Characteristic information can be any information associated with the user name, for example, name, address, email address, election of a follow status on a social networking service, selection as a friend on a social networking service, election of a like status on a social networking service, demographic information, such as gender, race, age, marital status, employment status, income, and home ownership, the like, or any combination thereof.

In one embodiment, the software application obtains user information associated with a user name. User information can be obtained by performing a user information query of databases provided by a social networking service that store user information. For example, the software application may be implemented as a “web crawler” that searches websites for text associated with location information. By way of another example, a user information query can be performed by API, web query, or SQL request. The application program interface can access lists of user information to obtain location information and associated characteristic information. In one embodiment, the software application may search for user information in a specified format, such as numbers that represent a zip code, the word “Apartment”, “Apt”, or “Suite” followed by at least one number, words representing a city, words representing a state, words representing a country, the like, or any combination thereof. In one embodiment, the software application may request user information from predetermined web applications, public or private data sources, or may search the user information associated with the applications for location information in the manner described above. In one embodiment, the user or another entity may provide the software application with user information. User information can be stored as user data in a storage database.

In one embodiment, the method has the step of receiving public information associated with a user name. Public information can be name, address, email address, demographic information, such as gender, race, age, marital status, employment status, income, and home ownership, the like, or any combination thereof. Public information can be obtained by performing a public information query of databases provided by consumer data warehouses that store public information. Consumer data warehouses can be any storage mechanism for storing information about a user, for example, public and private databases, search engines, report agencies, data aggregators, or the like. The step of obtaining public information associated with a user name can be repeated with regard to additional consumer data warehouses until the desired amount of public information is obtained. In one embodiment, once the desired amount of public information associated with a user name has been received, the step of receiving public information associated with a user name is performed with regard to another user. The public information query can be performed by an API, web query, or SQL request. The public information can be stored as public data in a storage database.

In one embodiment, the method has the step of comparing the public information to the user information, e.g. location information and/or characteristic information, to determine a match.

In one embodiment, the method has the step of determining a user match. A user match can be determined when public information associated with a user name matches user information, for example location information or characteristic information, associated with the same or substantially the same user name. Any public information associated with a user name that matches either location information or characteristic information associated with the same user name can be stored in the storage database.

In one embodiment, the method has the step of identifying at least one location that matches the location associated with the user name. In one embodiment, the identification of at least one location that matches the location associated with the user name can be performed by parsing user information and/or public information. In one embodiment, the software application parses user information and/or public information and identifies at least one location that matches the location associated with the user name. The software application may apply at least one rule to the user information and public information to identify at least one location that matches the location associated with the user name, for example, a rule that matches a location with a user name where the location is represented within 10 characters of the name associated with a user name. In one embodiment, the location result with the highest degree of similarity to the location information is selected as the verified location. For example, if the location information is “1600 Pennsylvania,” and the software application identifies a “Pennsylvania Street” and a “Pennsylvania Avenue” in close proximity, the verified location is selected as the street that includes a listing at “1600”, or a street that matches another piece of location information.

In one embodiment, the method has the step of verifying the location identified by comparing the user information and/or public information against a storage database of known locations thereby determining a verified location.

In one embodiment, the method has the step of determining a user name for display. In one embodiment, the software application performs the step of determining a user name for display. In one embodiment, a user name with a desired piece of characteristic information associated with the user name is determined. In one embodiment, a user name with multiple desired pieces of characteristic information associated with the user name is determined. A user name associated with a desired piece of characteristic information associated with the user name is determined by filtering a list of user names by the desired piece of characteristic information. In one embodiment, a list of user names is filtered by a desired piece of location information and a desired piece of characteristic information. In one embodiment, a filter query can be performed to determine user names with desired pieces of characteristic information and/or location information. A filter query is a query transmitted to the database to obtain the location associated with a user name where a desired piece of characteristic information is associated with the user name. A filter query can be performed by a web query, standard query language (SQL) request, or the like. Upon receipt of the filter query, the location associated with a user name with the desired piece of characteristic information associated with the user name can be transmitted to the electronic device.

For example, where the operator desires to display locations associated with a user name and the desired piece of characteristic information is female and the user name follows a specific profile on a social networking service, the list of user names are filtered by the characteristic information of female and those that follow a specific person on a social networking service. In one embodiment, the locations of the filtered user names are transmitted to the electronic device.

In one embodiment, the method has the step of providing the location associated with a user name for display. In one embodiment, the software application performs the step of providing the location associated with a user name for display. The location associated with a user name can be provided for display by geolocating the location and displaying the geolocated location on a display map. A map display 200 is any type of graphic map display 200 generated by the software application. The location can be geolocated by determining the latitudinal and longitudinal coordinates associated with the location. The geolocated location is then applied to a reference geographical map. The geolocated location is assigned to a pixel value associated with a map display 200 thereby creating a map point. A “map point” is a point mapped on a geographic map with pixel values representing the location of the point relative to a particular map display 200 and/or relative to one other point associated with the map display 200. The software application utilizes a known pixel size to identify a map point.

In one embodiment, the method has the step of assigning a marker to the pixel value of the location associated with the user name thereby allowing for the location to be viewed on the map display 200. In one embodiment, the software application assigns a marker to the pixel value of the location. By assigning a marker to a pixel value of a location, the map display 200 is populated with a marker representing the location of a user.

While the marker can be graphically represented as a graphic having any shape, size, color, symbol, shading, border, animation, or design, the marker is preferably represented by a tear-drop shape.

In one embodiment, the method has the step of identifying a collection of overlapping markers. A collection of overlapping markers has at least two markers. A marker may overlap with only one other marker or a marker may be overlapped by multiple other markers. In one embodiment, the software application identifies whether the displayed graphical markers will result in overlapping graphical markers.

In one embodiment, the method has the step of creating a consolidated marker to indicate a collection of overlapping markers. The consolidated marker does not overlap with any other marker or consolidated graphic marker depicted on the map display 200.

In one embodiment, the method has the step of determining if a zoom level for the map display 200 has been changed. If the zoom level has been changed, the method has the step of identifying a collection of overlapping markers and creating a consolidated marker if a collection of overlapping markers is identified. In one embodiment, where the zoom level of the map display 200 is changed, the method has the step of recalculating a pixel value for each map point and thus the associated markers. Thus, a map point that is represented by an overlapping marker in one zoom level of the map display 200 may not be represented by an overlapping marker at a different zoom level of the map display 200.

In one embodiment, the method has the step of consolidating the collection of markers into multiple consolidated markers 220. In one embodiment, the collection of markers is consolidated into multiple consolidated markers 220 where the collection of markers represented by a consolidated marker exceeds a threshold number. For example, if the threshold number is ten, and 15 markers are present on the display map, the markers are consolidated into two consolidated markers 220.

The consolidated graphic marker can be displayed as a graphic having any shape, size, color, symbol, shading, border, animation, or design. For example, a consolidated graphic marker can be rendered in a square shape, rectangular shape, cube shape, a circle, an oval, a donut shape, a star, a letter, a number, a thumbnail image, or any other shape or size of a graphic or image to indicate a point or location on a map display 200. In one embodiment, consolidate markers have the same or different shape or size as the marker.

In one embodiment, the method has the step of displaying a number representing the number of markers indicated by a consolidated marker on the consolidated marker. Where a number is not associated with a marker, the operator can determine that the marker is not a consolidated marker.

In one embodiment, the method has the step of selecting a geographic area on the display map for displaying locations associated with a user name within the selected geographic area. In one embodiment, each pixel of the display map is assigned latitudinal and longitudinal coordinates associated with the location of the pixel. The perimeter of a geographic area is outlined on the display map using an interface of the electronic device. The geographic area of the display map is identified when the perimeter of the geographic area is enclosed. The geographic area can be any shape, for example, circle, square, polygon, freeform shape, or the like. In one embodiment, a geographic area is determined to be closed when a pixel selected while outlining the perimeter of the geographic area is re-selected while outlining the perimeter of a geographic area. The longitudinal and latitudinal coordinates of each pixel selected as the perimeter of the geographic area are transmitted to a database. A coordinate query is submitted to the database requesting the locations associated with a user name with longitudinal and latitudinal coordinates that lie within the geographical area. The locations obtained from the coordinate query are then applied to the geographical map. A marker is assigned to the pixel value of each location. Where a collection of markers will cause overlap between markers, a consolidated marker is created to indicate a collection of overlapping markers.

By way of example, a location associated with a user name of a social networking service is displayed on a map display 200 in the following manner. A user information query obtains user information associated with a user name from a social network service. In this example, the user information obtained is location information and characteristic information, specifically the name, location, and gender of the user name. The user information is stored as user data in a storage database.

A public information query obtains public information stored on a private database. In this example, the public information obtained is name, address, marital status, occupation, and ethnicity of the user. The public information is stored on the database as public data.

The public information is compared to the user information and a user match is established by matching the name and address of the user data with the name and address of the public data. The public information of the marital status, occupation, and ethnicity is added to the user data associated with the user name and stored in the storage database. The steps of obtaining public information are repeated with regard to other consumer data warehouses until a desired amount of public information is obtained.

The operator desires to know the location associated with the user names who follow a specific person on a social networking service and who are female. A filter query is transmitted to the database in the form of a web query to determine user names who follow a specific person on a social networking service and who are female. Upon receipt of the filter query, the location associated with all user names in the database who follow a specific person on a social networking service and who are female is transmitted to the electronic device.

The location associated with a user name is geolocated on a map display 200 by determining the latitudinal and longitudinal coordinates associated with each location. The geolocated locations are then applied to a reference geographical map. A marker is assigned to the pixel value of each location. Where a collection of markers will cause overlap between markers, a consolidated marker to indicate a collection of overlapping markers is created.

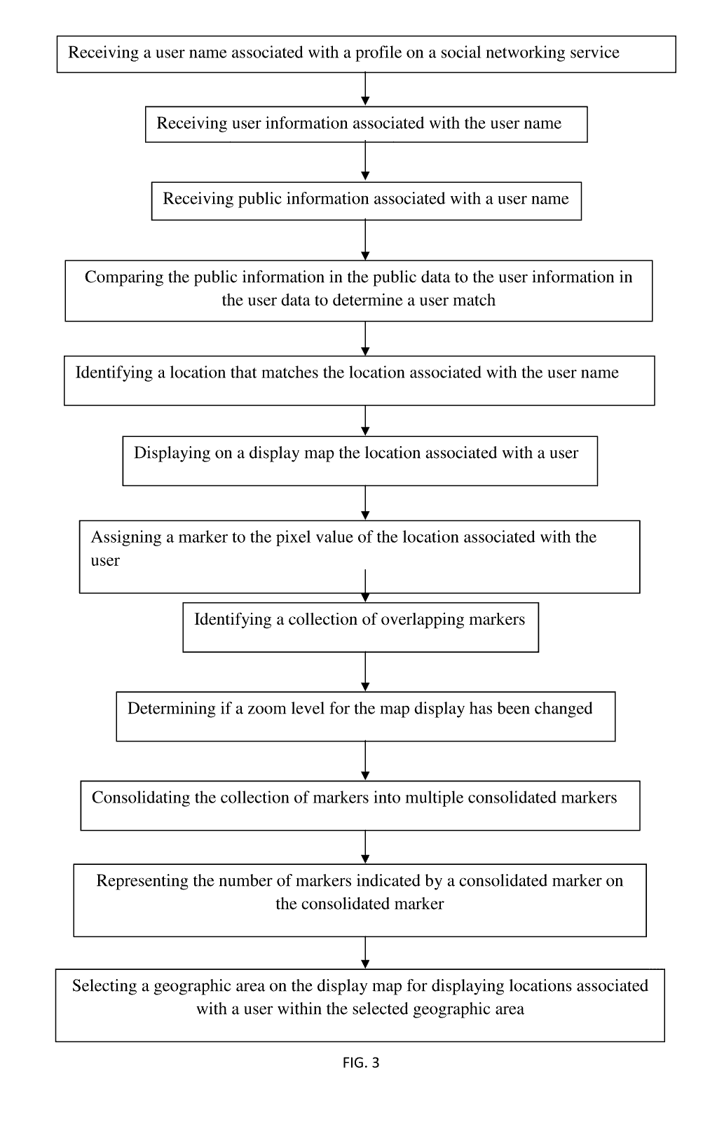

As shown in FIG. 3, for example, a map display 200 showing graphic markers 210 and consolidated markers 220 are depicted. Map display 200 is depicted with six consolidated markers 220 and three graphic markers 210. Consolidated marker 220A is represented with number 15 representing 15 locations associated with a user name, consolidated marker 220B is represented with number 23 representing 23 locations associated with a user name, consolidated marker 220C is represented with number 14 representing 14 locations associated with a user name, consolidated marker 220D is represented with number seven representing seven locations associated with a user name, consolidated marker 220E is represented with number three representing three locations associated with a user name, and consolidated marker 220F is represented with number two representing two locations associated with a user name.

Here, the operator desires to know the user names associated with France. The operator draws a square on the display map around the geographic area representing France using a mouse of an electronic device, thereby limiting the displayed location associated with a user name to the country of France.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A method comprising:
receiving, by one or more processors, a user name associated with a profile on a social networking service;
receiving, by one or more processors, user information associated with a user name;
receiving, by one or more processors, public information associated with a user name;
determining, by one or more processors, a user match;
identifying, by one or more processors, a location that matches the location associated with the user name; and
providing, by the one or more processors, the location associated with a user name for display.

2. A method of claim 1, the determining a user match further comprising: comparing, by one or more processors, the public information to the user information.

3. A method of claim 1 further comprising: determining, by one or more processors, a user name for display;

4. A method of claim 3, the determining a user name for display further comprising:
filtering, by one or more processors, a list of user names by the desired piece of characteristic information.

5. A method of claim 1 further comprising: verifying, by one or more processors, an identified location by comparing the identified location against a storage database of known locations.

6. A method of claim 1, the identifying a location that matches the location associated with the user name further comprising: parsing, by one or more processors, user information and/or public information.

7. A device comprising: a memory; and one or more processors to:
receive a user name associated with a profile on a social networking service;
receive user information associated with a user name;
receive public information associated with a user name;
determine a user match;
identify a location that matches the location associated with the user name; and
provide the location associated with a user name for display.

8. A device of claim 7, the one or more processors, when determining a user match, being further to: compare the public information to the user information.

9. A device of claim 7, the one or more processors are further to determine a user name for display.

10. A device of claim 9, the one or more processors, when determining a user name for display, being further to: filter a list of user names by the desired piece of characteristic information.

11. A device of claim 7, the one or more processors are further to verify an identified location by comparing the identified location against a storage database of known locations.

12. A device of claim 7, the one or more processors, when identifying a location that matches the location associated with the user name, are further to: parse user information and/or public information.

13. A non-transitory computer-readable medium comprising: one or more instructions that, when executed by one or more processors, cause the one or more processors to:
receive a user name associated with a profile on a social networking service;
receive user information associated with a user name;
receive public information associated with a user name;
determine a user match;
identify a location that matches the location associated with the user name; and
provide the location associated with a user name for display.

14. The non-transitory computer-readable medium of claim 13, further comprising: one or more instructions that, when causing the one or more processors to determine a user match, cause the one or more processors to: compare the public information to the user information.

15. The non-transitory computer-readable medium of claim 13, further comprising: one or more instructions that, when executed by the one or more processors, cause the one or more processors to determine a user name for display.

16. The non-transitory computer-readable medium of claim 15, further comprising: one or more instructions that, when causing the one or more processors to determine a user name for display, cause the one or more processors to: filter a list of user names by the desired piece of characteristic information.

17. The non-transitory computer-readable medium of claim 13, further comprising: one or more instructions that, when executed by the one or more processors, cause the one or more processors to verify an identified location by comparing the identified location against a storage database of known locations.

18. The non-transitory computer-readable medium of claim 13, further comprising: one or more instructions that, when causing the one or more processors to identify a location that matches the location associated with the user name, cause the one or more processors to: parse user information and/or public information.
